(19) United States
(12) Patent Application Publication
(10) Pub. No.: US 2014/0281188 A1
(43) Pub. Date: Sep. 18, 2014

(54) METHOD OF UPDATING MAPPING INFORMATION AND MEMORY SYSTEM AND APPARATUS EMPLOYING THE SAME

(71) Applicant: SAMSUNG ELECTRONICS CO., LTD., Suwon-si (KR)

(72) Inventor: MIN-CHEOL KWON, SEOUL (KR)

(73) Assignee: SAMSUNG ELECTRONICS CO., LTD., Suwon-si (KR)

(21) Appl. No.: 14/194,126

(22) Filed: Feb. 28, 2014

(30) Foreign Application Priority Data
Mar. 15, 2013 (KR) 10-2013-0028243

(51) Int. Cl. G06F 12/10

(52) U.S. Cl. CPC G06F 12/1009
USPC 711/104; 711/206

(57) ABSTRACT

A method of updating mapping information for a memory system comprises generating write transaction information based on multiple write requests issued by a host, performing program operations in the memory system based on the write transaction information, and following completion of the program operations, updating mapping information based on an order in which the write requests were issued by the host.

### CROSS-REFERENCE TO RELATED APPLICATIONS

This application claims priority under 35 U.S.C. §119 to Korean Patent Application No. 10-2013-0028243 filed on Mar. 15, 2013, the subject matter of which is hereby incorporated by reference.

### BACKGROUND OF THE INVENTION

The inventive concept relates generally to memory systems and methods of managing mapping information of the memory systems. More particularly, certain embodiments of the inventive concept relate to methods of updating mapping information in a multi-bank memory system and memory systems and apparatuses employing the methods.

A solid state drive (SSD) is a type of memory system that stores data in one or more semiconductor memory devices. SSDs are increasingly used to replace hard disk drives (HDDs) and other memory systems used for persistent data storage.

Researchers are engaged in ongoing efforts to improve various aspects of SSD performance, such as the rate at which SSDs process requests from a host. In some systems, this rate may be increased by processing multiple requests in parallel. These requests may be handled, for instance, by multiple different memory banks operating in parallel, i.e., in a multi-bank SSD. Nevertheless, the overall processing speed of an SSD may be limited by delays related to internal operations such as memory mapping. In a multi-bank SSD in particular, a single memory map may be shared by different memory banks, so memory mapping operations can create a bottleneck for those memory banks.

In a typical SSD, memory mapping operations are required when data is updated. For example, in an SSD comprising flash memory devices, a data update operation typically comprises invalidating data at a current physical address, storing replacement data at a new physical address, and remapping a logical address associated with the current physical address to the new physical address.

Because memory mapping operations can limit the performance of SSDs, there is a general need for improved methods for managing mapping information without deteriorating data update performance.

### SUMMARY OF THE INVENTION

In one embodiment of the inventive concept, a method of updating mapping information for a memory system comprises generating write transaction information based on multiple write requests issued by a host, performing program operations in the memory system based on the write transaction information, and following completion of the program operations, updating mapping information based on an order in which the write requests were issued by the host.

In another embodiment of the inventive concept, a memory system comprises multiple memory devices each comprising multiple memory banks, and a memory controller that generates write transaction information based on write requests, controls program operations based on the write transaction information, and, after the program operations are completed, updates mapping information based on an order in which the write requests were issued.

In yet another embodiment of the inventive concept, an apparatus comprises a memory controller configured to generate write transaction information based on multiple write requests received from a host, control program operations performed on a plurality of memory devices based on the write transaction information, and, after the program operations are completed, update mapping information based on an order in which the write requests were issued by the host.

These and other embodiments of the inventive concept can potentially improve the overall performance of a memory system by raising the efficiency of memory mapping operations through the use of write transaction information.

### BRIEF DESCRIPTION OF THE DRAWINGS

The drawings illustrate selected embodiments of the inventive concept. In the drawings, like reference numbers indicate like features.

FIG. 1 is a diagram of a memory system according to an embodiment of the inventive concept.

FIG. 2 is a diagram illustrating configurations of channels and banks of a storage device of FIG. 1, according to an embodiment of the inventive concept.

FIG. 3 is a circuit diagram of a flash memory device in the memory system of FIG. 1, according to an embodiment of the inventive concept.

FIG. 4 is a diagram of a storage structure for a single memory device in the storage device of FIG. 1, according to an embodiment of the inventive concept.

FIG. 5 is a circuit diagram of a memory block in a single memory device in the storage device of FIG. 1, according to an embodiment of the inventive concept.

FIG. 6 is a sectional view of a memory cell in the memory block of FIG. 5, according to an embodiment of the inventive concept.

FIG. 7 is a block diagram illustrating a software architecture for the memory system of FIG. 1, according to an embodiment of the inventive concept.

FIG. 8A is a diagram illustrating a method of updating mapping information in a multi-bank memory system according to an embodiment of the inventive concept.

FIG. 8B is a diagram further illustrating the method of FIG. 8A, according to an embodiment of the inventive concept.

FIG. 8C is a diagram further illustrating the method of FIG. 8A, according to an embodiment of the inventive concept.

FIG. 9A is a diagram illustrating another method of updating mapping information in a multi-bank memory system according to an embodiment of the inventive concept.

FIG. 9B is a diagram further illustrating the method of FIG. 9A, according to an embodiment of the inventive concept.

FIG. 9C is a diagram further illustrating the method of FIG. 9A, according to an embodiment of the inventive concept.

FIG. 10 is a diagram illustrating a memory controller in the memory system of FIG. 1, according to an embodiment of the inventive concept.

FIG. 11 is a diagram illustrating a process for updating mapping information, according to an embodiment of the inventive concept.

FIG. 12A is a diagram illustrating a process for updating a mapping information updating sequence using link information, according to an embodiment of the inventive concept.

FIG. 12B is a diagram further illustrating the process of FIG. 12A, according to an embodiment of the inventive concept.

FIG. 13 is a flowchart illustrating a method of updating mapping information, according to an embodiment of the inventive concept.

FIG. 14 is a flowchart illustrating an operation for generating write transaction information in the method of FIG. 13, according to an embodiment of the inventive concept.

FIG. 15 is a flowchart illustrating an operation for updating mapping information in the method of FIG. 13, according to an embodiment of the inventive concept.

FIG. 16 is a flowchart illustrating an operation for updating mapping information of FIG. 13, according to another embodiment of the inventive concept.

FIG. 17 is a block diagram illustrating an electronic device comprising a memory system, according to an embodiment of the inventive concept.

FIG. 18 is a block diagram illustrating another electronic device comprising a memory system, according to an embodiment of the inventive concept.

FIG. 19 is a block diagram illustrating a network system comprising a memory system, according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terminology used to describe particular embodiments is illustrative of those embodiments, and is not intended to limit the inventive concept. An expression in singular form encompasses the plural form as well, unless indicated to the contrary. Terms such as “comprising”, “including” or “having,” etc., indicate the presence of stated features and are not intended to preclude the presence of other features.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and will not be interpreted in an idealized or overly formal sense unless expressly so defined herein.

FIG. 1 is a diagram illustrating a memory system 100 according to an embodiment of the inventive concept.

Referring to FIG. 1, memory system 100 comprises a memory controller 110 and a storage device 120. Memory controller 110 is connected to storage device 120 through N channels CH1 through CHN.

Memory controller 110 controls memory system 100 to perform read, write, and erase operations on storage device 120 in response to requests from a host. Some of these operations may require updates to address mapping information. Accordingly, memory controller 110 may perform a method for updating the address mapping information as shown in FIGS. 13 through 16.

The N channels CH1 through CHN are independent signal paths through which memory controller 110 and storage device 120 may exchange signals. Each channel facilitates communication for multiple memory devices. For example, in FIG. 1, each channel provides communication for a corresponding group of four flash memory devices. These groups of flash memory devices are labelled as groups 121 through 123.

Although FIG. 1 shows storage device 120 with flash memory devices, it could alternatively be implemented by other with other forms of nonvolatile memory, such as phase change RAMs (PRAMs), ferroelectric RAM (FRAMs), or magnetic RAMs (MRAM). Storage device 120 may also be a combination of different types of nonvolatile memory.

FIG. 2 is a diagram illustrating configurations of channels and banks of storage device 120 of FIG. 1, according to an embodiment of the inventive concept.

Referring to FIG. 2, storage device 120 comprises flash memory devices arranged in groups 121 through 123, which are connected to channels CH1 through CHN. Each of the groups comprises M+1 flash memory devices, also referred to as memory banks Bank0 through BankM. For example, group 121 comprises flash memory devices 121-0 through 121-M. Each of the flash memory devices in storage device 120 can be uniquely identified by a bank number and a channel number.

Channels CH1 through CHN comprise independent buses capable of transmitting and receiving commands, addresses, and data to and from the corresponding groups 121, 122, and 123. Flash memory devices connected to different channels operate independently. A flash memory device of a particular bank of a particular channel may be determined based on a logical block address (LBA) transmitted from the host.

To improve performance of memory system 100 physical page addresses can be assigned to logical addresses such that write requests from a host are executed in a channel or bank that is in a standby mode, or in a bank that is sequentially shifted page-by-page in a single channel.

FIG. 3 is a circuit diagram of flash memory device 121-0 in storage device 120, according to an embodiment of the inventive concept.

Referring to FIG. 3, flash memory device 121-0 comprises a memory cell array 21, control logic 22, a voltage generator 23, a row decoder 24, and a page buffer 25.

Control logic 22 outputs various control signals for writing data to memory cell array 21 or reading data from memory cell array 21 based on a command CMD, an address ADDR, and a control signal CTRL received from memory controller 110. A control signal output by control logic 22 may be transmitted to voltage generator 23, row decoder 24, and page buffer 25.

Voltage generator 23 generates a driving voltage VWL for driving multiple word lines WL based on a control signal received from control logic 22. Driving voltage VWL may be a write voltage (or program voltage), a read voltage, an erase voltage, or a pass voltage, for example.

Row decoder 24 activates a part of word lines WL based on a row address. In detail, during a read operation, row decoder 24 may apply read voltages to selected word lines and may apply pass voltages to word lines not selected. Meanwhile, during a write operation, row decoder 24 may apply write voltages to selected word lines and may apply pass voltages to word lines not selected.

Page buffer 25 is connected to memory cell array 21 via multiple bit lines BL. Page buffer 25 temporarily stores data to be written to memory cell array 21 or data read from memory cell array 21.

FIG. 4 is a diagram of a storage structure for a single memory device in storage device 120 of FIG. 1, according to an embodiment of the inventive concept.

Referring to FIG. 4, memory cell array 21 is a flash memory cell array comprising “a” memory blocks BLK0 through BLKa−1. Each of blocks BLK0 through BLKa−1 comprises “b” pages PAG0 through PAGb−1, and each of pages PAG0 through PAGb−1 comprises “c” sectors SEC0 through SECc−1. Although FIG. 4 shows pages PAG0 through PAGb−1 and sectors SEC0 through SECc−1 regarding block BLK0 only for convenience of illustration, the other blocks BLK1 through BLKa−1 may have the same structure as block BLK0.

FIG. 5 is a circuit diagram of a memory block BLK0 in a single memory device in storage device 120 of FIG. 1, according to an embodiment of the inventive concept. Other memory blocks may be implemented similar to memory block BLK0.

Referring to FIG. 5, memory block BLK0 comprises “d” strings STR each comprising eight memory cells MCEL connected in series in a direction parallel to bit lines BL0 through BLd−1. Each string STR comprises a drain selecting transistor Str1 and a source selecting transistor Str2 that are respectively connected to the two outermost memory cells MCEL from among memory cells MCELs connected in series.

In a NAND flash memory device having a structure as shown in FIG. 5, erase operations are performed block by block, and program operations are performed page PAG by page PAG corresponding to word lines WL0 through WL7. Although FIG. 5 shows an example in which 8 pages PAG are arranged in a single block in correspondence to 8 word lines WL0 through WL7, each of blocks BLK0 through BLKa−1 of memory cell array 21 could have different numbers of memory cells and pages from the numbers of memory cells MCEL and pages PAG of FIG. 5.

FIG. 6 is a sectional view of a memory cells MCEL in memory block BLK0 of FIG. 5.

Referring to FIG. 6, a source S and a drain D are formed on a substrate SUB, and a channel region is formed between source S and drain D. A floating gate FG is formed above the channel region, where an insulation layer, such as a tunnelling insulation layer, is arranged between the channel region and floating gate FG. A control gate CG is formed above floating gate FG, where an insulation layer, such as a blocking insulation layer, is arranged between floating gate FG and control gate CG. Voltages required for program operation, erase operation, and read operation regarding memory cells MCEL are be applied to substrate SUB, source S, and control gate CG.

In a flash memory device, data stored in memory cells MCEL may be read according to threshold voltages Vth of memory cells MCEL. Here, threshold voltage Vth of memory cell MCEL may be determined based on a relative quantity of electrons stored in floating gate FG. The more electrons stored in floating gate FG, the higher threshold voltage Vth of memory cell MCEL.

Electrons stored in floating gate FG of memory cell MCEL may leak in a direction indicated by an arrow due to various reasons, and thus threshold voltage Vth of memory cell MCEL may be changed. For example, electrons stored in floating gate FG may leak due to wear of memory cell MCEL. More specifically, as memory cell MCEL is repeatedly accessed for program operations, erase operations, or read operations, an insulation layer between a channel region and floating gate FG may wear off, and thus electrons stored in floating gate FG may leak. As another example, electrons stored in floating gate FG may leak due to high temperature stress or a difference of temperatures during a program operation and a read operation. The leakage deteriorates reliability of a memory device.

In a flash memory device, data is written or read page by page, whereas data is electrically erased block by block. Consequently, data updates for a particular logical address may require writing to a new physical address, and remapping of the logical address. A process for performing the remapping will be described below with reference to FIG. 7.

FIG. 7 is a block diagram illustrating software architecture of memory system 100, according to an embodiment of the inventive concept. In this example, it is assumed that storage device 120 comprises flash memory devices.

Referring to FIG. 7, memory system 100 has a hierarchical software structure comprising an application 101, a file system 102, a flash translation layer (FTL) 103, and a flash memory 104 as illustrated. Here, flash memory 104 refers to the physical flash memory device 121-0 of FIG. 3.

Application 101 refers to firmware for processing user data. Application 101 may be, for instance, a document processing software (e.g., a word processor), a calculator software, or a document viewer (e.g., a web browser). In response to user inputs, application 101 processes user data and transmits a command for storing processed user data in flash memory 104 to file system 102.

File system 102 refers to a structure or software used for storing user data in flash memory 104. In response to a command from application 101, file system 102 allocates physical addresses at which user data is to be stored. Examples of file system 102 include a file allocation table (FAT) file system and an NTFS.

In FTL 103, logical addresses transmitted from file system 102 are translated to physical addresses for performing read/write operations in flash memory 104. In FTL 103, logical addresses are translated to physical addresses according to map table information. Logical addresses may be divided into logical pages, logical page number (LPN) may be allocated to the logical page, and the LPN may be translated to physical page number according to map table information. Alternatively, LPN may be allocated by dividing logical addresses into logical pages, the LPN may be translated to virtual page number (VPN) according to map table information, and physical page numbers (PPN) may be acquired based on the VPN.

Addresses may be mapped by using a page mapping method or a block mapping method. The page mapping method is a method of mapping addresses page by page, whereas the block mapping method is a method of mapping addresses block by block. Furthermore, a hybrid mapping method, which is a combination of a page mapping method and a block mapping method, may also be used. Here, physical addresses indicate data storage locations of flash memory 104. In FTL 103, logical block address (LBA) may be divided into LPNs page by page, and then the LPNs may be translated to PPN indicating physical storage locations of a flash memory device.

FIGS. 8A through 8C are diagrams illustrating methods of updating mapping information according to a sequence in which program operations are completed in response to write requests in a multi-bank memory system, according to an embodiment of the inventive concept.

FIG. 8A shows a sequence in which write requests are issued by a host with respect to a same logical page. As illustrated in FIG. 8A, write requests are received from the host in the order of Write A, Write B, and so on with respect to the same logical page LPN 1000.

FIG. 8B shows an example in which write requests made in the order as shown in FIG. 8A are processed by a flash memory device. As illustrated in FIG. 8B, in response to the first write request, PPN a is allocated and Write A is performed at a flash memory device at a Bank 0, and, in response to the second write request, PPN b is allocated and Write B is performed at a flash memory device at a Bank 1.

FIG. 8C shows a sequence of updating mapping information in map table information after program operations are performed according to write requests. The map table may be referred to as a L2P map.

Referring to FIG. 8C, based on the order in which program operations are completed, map table information is updated, such that LPN 1000 is mapped to the PPN a after Write A. Next, map table information is updated, such that LPN 1000 is mapped to the PPN b after Write B. As a result, a PPN corresponding to LPN 1000 in the map table is normally updated from PPN a to PPN b.

FIGS. 9A through 9C are diagrams illustrating another method of updating mapping information according to a sequence in which program operations are completed in response to write requests in a multi-bank memory system, according to an embodiment of the inventive concept.

FIG. 9A shows a sequence of write requests provided by a host with respect to a same logical page. As illustrated in FIG. 9, write requests are received from a host in the order of Write A, Write B, and so on.

FIG. 9B shows an example in which write requests made in the order as shown in FIG. 9A are processed by a flash memory device. As illustrated in FIG. 9B, before PPN a is allocated and Write A is performed at a flash memory device at a Bank 0 in response to the first write request, it is necessary to perform erase operation at a block including the PPN a. Meanwhile, no erase operation is performed before PPN b is allocated and Write B is performed at a flash memory device at a Bank 1 in response to the second write request. Therefore, actual program operations are performed at Bank 1 first and then in Bank 0. In other words, the actual program operations are performed in the order of Write B and Write A.

FIG. 9C shows a sequence of updating mapping information in map table information after program operations are performed according to write requests. As illustrated in FIG. 9C, based on the order in which program operations are completed, map table information is updated, such that LPN 1000 is mapped to the PPN b after Write B. Next, map table information is updated, such that LPN 1000 is mapped to the PPN a after Write A. As a result, a PPN corresponding to LPN 1000 in the map table is updated from PPN a to PPN b, regardless of the order write requests are issued with respect to a same LPN. Therefore, unlike the sequence of issuing write requests with respect to a same LPN, a PPN corresponding to LPN 1000 is updated from PPN b to PPN a in the map table. Therefore, in the map table, a PPN corresponding to old data prior to update is mapped to LNP 1000 instead of the newest data.

To resolve problems that may arise in methods that determine a sequence of updating mapping information based on the order of completing program operations in response to write requests, certain embodiments of the inventive concept provide methods of managing mapping information regarding write requests with respect to a same LPN based on the order the write requests are issued.

FIG. 10 is a diagram illustrating memory controller 110 of FIG. 1, according to an embodiment of the inventive concept.

Referring to FIG. 10, memory controller 110 comprises a central processing unit (CPU) 111, a read only memory (RAM) 112, a random access memory (RAM) 113, a host interface 114, a request queue 115, a sub-request queue 116, a map update queue 117, a memory interface 118, and a bus 119.

The components of memory controller 110 may be electrically connected via bus 119. Host interface 114 implements a data exchange protocol corresponding to a host connected to memory system 100 and interfaces between memory system 100 and the host. Host interface 114 may be, for instance, an advanced technology attachment (ATA) interface, a serial advanced technology attachment (SATA) interface, a parallel advanced technology attachment (PATA) interface, a universal serial bus (USB) interface, a serial attached small computer system (SAS) interface, a small computer system interface (SCSI), an eMMC (embedded multimedia card) interface, or a unix file system (UFS) interface. However, the above-stated interfaces are merely examples, and the inventive concept is not limited thereto. Host interface 114 may exchange commands, addresses, and data with a host under the control of CPU 111.

Program codes and data required for controlling operations performed in memory system 100 may be stored in ROM 112. For example, program codes for implementing the method of updating mapping information as shown in the flowcharts of FIGS. 13 through 16 may be stored in ROM 112.

Program codes and data read from ROM 112 may be stored in RAM 113. Furthermore, data received via host interface 114 or data received from storage device 120 via memory interface 118 may also be stored in RAM 113.

CPU 111 controls overall operations of memory system 100 by using program codes and data stored in RAM 113. For example, where memory system 100 is turned on, CPU 111 may read program codes and data required for controlling operations performed in memory system 100 from ROM 112 and store the program codes and the data in RAM 113. CPU 111 may read map table information from storage device 120 and store the map table information in RAM 113. In detail, when memory system 100 is turned on, CPU 111 may read map table information from storage device 120 and store the map table information in RAM 113. Next, before memory system 100 is turned off, CPU 111 reads the map table information from RAM 113 and controls memory system 100 to write data in storage device 120.

One or more I/O requests received from a host via host interface 114 are sequentially stored in request queue 115. I/O requests may include, for instance, write requests, erase requests, or read requests. Furthermore, I/O requests may be defined as command codes. Therefore, request queue 115 may store write command codes, erase command codes, or read command codes. If write requests are received from a host, write command codes, a starting logical block address (LBA), and information regarding the number of LBAs for performing write operations may be stored in request queue 115.

I/O requests stored in request queue 115 may have a format that cannot be directly processed by storage device 120 including flash memory devices, for example. Therefore, CPU 111 reads I/O requests stored in request queue 115 and divides the I/O requests into sub-requests, such that storage device 120 may perform requested operations. Next, logical addresses corresponding to the sub-requests are translated to physical address that may be recognized by storage device 120. An I/O request may be divided into sub-requests having a format based on which program operations and read operations may be performed in storage device 120. Size of a sub-request may be in the unit of pages that may be independently processed in a flash memory device. A sub-request may include command codes and LPN.

CPU 111 translates LPN allocated by dividing an I/O request into sub-requests to PPNs of a flash memory device. CPU 111 may translate LPN allocated by dividing an I/O request into sub-requests to VPN and may acquire PPN based on the VPNs. CPU 111 generates transaction information with respect to each of sub-requests. CPU 111 may generate write transaction information when an I/O request regarding write operation is divided into sub-requests. Write transaction information may include LPN, PPN, and dependency information. Here, the dependency information is information generated based on the order write requests are issued.

CPU 111 translates PPN regarding LPN, such that sub-requests regarding a write request may be performed at multiple banks in distributed fashion. Where CPU 111 generates transaction information of sub-requests regarding a write request, CPU 111 may translate PPN regarding LPN, such that a memory device is accessed at multiple banks successively and alternately. Therefore, the banks may be accessed in interleaved fashion.

Dependency information may include, for instance, time stamp information indicating times at which write requests are issued. As another example, dependency information may include link information indicating the order write requests regarding a same LPN are issued. CPU 111 may generate link information as described below. Where multiple write requests regarding a same LPN are pending, write transaction information regarding a same LPN may be generated, such that a previous write transaction information includes link information indicating a next write transaction and a new write transaction information includes link information indicating a previous transaction.

Therefore, where multiple write requests regarding a same LPN are pending, a sub-request including previous write transaction information may be searched for based on link information. In the same regard, when multiple write requests regarding a same LPN are pending, a sub-request including next write transaction information may be searched for based on link information.

CPU 111 stores sub-requests including such transaction information in sub-request queue 116. Sub-request queue 116 may store write command codes, LPNs, PPNs, and time stamp information. Alternatively, sub-request queue 116 may store write command codes, LPNs, PPNs, and link information. Sub-request queue 116 stores commands that are independently performed by respective memory devices. Therefore, sub-request queue 116 may also be referred to as a memory device command cue.

A sub-request is the unit by which flash memory devices constituting storage device 120 perform operations. Therefore, a sub-request may be the unit by which operations are issued.

CPU 111 may divide and manage sub-request queue 116 with respect to respective channels. Alternatively, CPU 111 may divide and manage sub-request queue 116 with respect to respective memory devices constituting storage device 120.

CPU 111 may adjust times for reading out I/O requests stored in request queue 115 in consideration of the number of memory devices performing operations simultaneously per channel. Operation states of memory devices may be determined by using an interruption method or a polling method.

Where program requests in storage device 120 are completed based on sub-requests read from sub-request queue 116, CPU 111 stores sub-requests in map update queue 117 in the order the program operations are completed. As a result, write transaction information corresponding to the completed program operations is stored in map update queue 117.

Memory interface 118 interfaces between memory controller 110 and storage device 120. Memory interface 118 transmits commands CMD, addresses ADDR, and control signals CTRL to storage device 120 via channels selected based on sub-requests read from sub-request queue 116 and may transmit data to be written to storage device 120 or receive read data from storage device 120. Memory interface 118 may process error correction code or manage blocks with errors for correcting errors in data read from storage device 120. CPU 111 may perform serialization among sub-requests of write requests regarding a same LPN as described below.

First, CPU 111 delays transmission of new sub-requests to storage device 120 until ongoing write operations regarding a same LPN are completed. In this case, because the ongoing write operations are completed after some time, some pipeline stall may occur. However, in this case, previous write operations may still be pending even after the period of time is elapsed due to flash programming mechanism. If a separate page buffering is required like in a case where it is necessary to buffer a predetermined number of pages to proceed to a next program step, the buffering may cause deadlock in such a processing method regarding a same LPN. In this case, a dummy write operation may be issued to forcefully complete a previous write operation regarding a same LPN.

Second, performance of program operation with respect to a new request after a pervious write request may be guaranteed by using dependency information among requests. Therefore, a new request may be performed at another bank after a previous program operation is completed. For another example, write operations may be sequentially performed at a same bank. The above described methods may feature longer program times due to delays of times at which program operations at respective banks of flash memory devices start.

In another method, serialization is performed while updating a logical address to physical address (L2P) map after completions of program operations, unlike above-described methods above in which serialization is performed before flash memory devices are programmed. The process of updating mapping information based on this method in which serialization is performed while updating a L2P map after completions of program operations is shown in FIG. 11.

Referring to FIG. 11, write requests are received from the host in the order of Write A, Write B, and so on with respect to the same logical page LPN 1000. CPU 111 uses a FTL firmware to translate LPN 1000 of the first write request Write A to a PPN a (Bank 0) and translate LPN 1000 of the second write request Write B to a PPN b (Bank 1).

FIG. 11 shows an example where it is necessary to perform an erase operation in a block including the PPN a before Write A is performed at a flash memory device of a Bank 0. In contrast, no erase operation is performed before Write B is performed at a flash memory device of a Bank 1 including the PPN b, according to the second write request. Therefore, actual program operations are completed on Bank 1 and Bank 0 in the order stated. In other words, actual program operations are performed in the order of Write B and Write A.

Referring to FIG. 1, CPU 111 controls write requests to update mapping information to a mapping table based on the order the write requests regarding a same LPN are issued. Therefore, a PPN corresponding to LPN 1000 in the map table is finally updated to PPN b based on the order the write requests regarding same LPN are issued.

Mapping information may be updated, for instance, based on the order write requests are issued, by using dependency information generated based on the order write requests are issued. Dependency information may be included in write transaction information.

Dependency information may include, for instance, time stamp information indicating times at which write requests are issued. For another example, dependency information may include link information indicating the order write requests regarding a same LPN are issued.

CPU 111 may determine a sequence of updating mapping information stored in map update queue 117 by using the time stamp information included in write transaction information. Typically, CPU 111 determines a sequence of updating mapping information with respect to sub-requests stored in map update queue 117 by using time stamp information included in write transaction information based on the order write requests are issued, and updates the map table information stored in RAM 113 with mapping information stored in map update queue 117 based on the determined updating sequence. Alternatively, CPU 111 may determine a sequence of updating mapping information stored in map update queue 117 by using link information included in write transaction information and update mapping information based on the sequence.

CPU 111 uses link information included in write transaction information, skips updating operation with respect to mapping information based on previously issued write requests, and update mapping information with respect to the latest write requests. CPU 111 changes a sequence of updating initially set mapping information based on the order program operations are completed, by using link information included in write transaction information based on the order write requests are issued. CPU 111 stores sub-request information in map update queue 117 in the order program operations are completed, and thus an updating sequence is initially set based on the order program operations are completed. Next, CPU 111 changes a sequence of updating mapping information, which relates to a same LPN, stored in map update queue 117 based on the order write requests are issued by using link information included in write transaction information.

FIGS. 12A and 12B are diagrams illustrating a process for updating a mapping information updating sequence using link information, in a method of updating mapping information according to an embodiment of the inventive concept.

FIG. 12A shows a link relationship based on write transaction information of pending write requests regarding a same LPN. As shown in FIG. 12A, based on link information included in write transaction information, link information indicating a next write transaction Write 100(2) is included in a write transaction Write 100(1), and link information including a previous write transaction Write 100(1) is included in a write transaction Write 100(2).

FIG. 12B is a diagram illustrating a process for changing a mapping information updating sequence using link information in map update queue 117.

FIG. 12B shows write transaction information stored in map update queue 117 in the order the write transaction information are stored, where mapping updating operations are sequentially performed along the direction indicated by an arrow.

Mapping information regarding write transactions including no link information are updated in map table information stored in RAM 113 in the order the mapping information are stored in map update queue 117. Next, mapping information regarding write transactions including no link information indicating previous write transactions are updated in the order the mapping information are stored in map update queue 117. However, mapping update is not performed with respect to pending write transactions including link information indicating previous write transactions and mapping information thereof are moved to the end of map update queue 117.

Referring to FIG. 12B, a write transaction Write 100(1) includes link information indicating a next pending write transaction, but does not include link information indicating a previous pending write transaction. Therefore, map table information is stored in RAM 113 using initial mapping information regarding write transaction Write 100(1). After the map table information regarding write transaction Write 100(1) is updated, link information is updated to erase link information indicating a previous transaction at a next write transaction Write 100(2) indicated by write transaction Write 100(1).

As described above, mapping information regarding write transactions is updated along the direction indicated by the arrow. Because a write transaction Write 100(3) includes link information indicating a previous pending write transaction Write 100(2), mapping update is not performed with respect to write transaction Write 100(3) and mapping information thereof is moved to the end of map update queue 117.

Next, because write transaction Write 100(2) does not include link information indicating a previous pending write transaction, map table information stored in RAM 113 is updated by using mapping information regarding write transaction Write 100(2). After the map table information regarding write transaction Write 100(2) is updated, link information is updated to erase link information indicating a previous transaction at a next write transaction Write 100(3) indicated by write transaction Write 100(2).

Finally, because write transaction Write 100(3) does not include link information indicating a previous pending write transaction, map table information stored in RAM 113 is updated using mapping information regarding write transaction Write 100(3).

Referring to FIGS. 12A and 12B, mapping information updated in order of Write 100(1), Write 100(2), and Write 100(3) with respect to multiple write transactions regarding a same LPN 100. In other words, mapping information are updated in the order write requests are issued.

Next, a method of updating mapping information according to an embodiment of the inventive concept will be described with reference to FIG. 13. The method of FIG. 13 may be performed by memory controller 110 of memory system 100 of FIG. 1. For example, it may be performed under the control of CPU 111 of memory controller 110 of FIG. 10.

Referring to FIG. 13, first, memory controller 110 generates write transaction information based on write requests issued by a host (S110). The write transaction information may include LPNs, PPNs, and dependency information generated based on the order write requests are issued.

Next, memory controller 110 controls memory system 100 to perform a program operation using write transaction information (S 120). Memory controller 110 transmits commands, addresses, control signals, and data for program-processing data corresponding to a LPN of a storage regions of a flash memory device at a bank designated by a PPN in the write transaction information to storage device 120. Memory devices of storage device 120 perform program operations using the commands, the addresses, the control signals, and the data transmitted from memory controller 110.

If multiple write requests regarding a same LPN are pending, memory controller 110 controls memory system 100 to perform program operations according to newly issued write requests after completing program operations according to previously issued write requests, based on dependency information included in the write transaction information. Memory controller 110 may perform program operations based on the order write requests are issued by delaying transmission of write transaction information regarding a new write request to storage device 120 until current program operations with respect to a same LPN are completed.

Next, memory controller 110 updates mapping information based on the order write requests are issued, after program operations are completed (S 130). Mapping information regarding write transactions is typically updated to map table information in the order write requests are issued, by using write transaction information regarding write request corresponding to completed program operations.

FIG. 14 is a flowchart illustrating details of operation S110 for generating write transaction information as shown in FIG. 13, according to an embodiment of the inventive concept.

Referring to FIG. 14, memory controller 110 divides write request received from a host based on data processing size of a memory device (S110-1). For example, write requests may be divided in the unit of pages that may be independently processed in a memory device.

Next, memory controller 110 performs address translation with respect to each of the write requests divided in operation S110-1 (S110-2). For example, memory controller 110 may allocate a LPN to each of the divided write requests and may translate allocated LPNs to PPNs.

Next, memory controller 110 generates write transaction information based on a result of the address translation (S110-3). Write transaction information may include LPNs with respect to a write request divided by page and PPNs translated in correspondence to the LPNs. Write transaction information may also include dependency information generated based on the order write requests are issued. Dependency information may include time stamp information indicating times at which write requests are issued, or it may include link information indicating the order pending write requests with respect to a same LPN are issued.

FIG. 15 is a flowchart illustrating an example of details of operation for updating mapping information of FIG. 13, according to an embodiment of the inventive concept.

An operation S130A for updating mapping information of FIG. 15 shows an example of updating mapping information in a case where dependency information included in write transaction information is time stamp information.

Memory controller 110 determines an order mapping information regarding write transactions corresponding to completed program operations are to be updated based on time stamp information included in write transaction information (S130-1A). The time stamp information includes information regarding times at which write requests are issued. Therefore, write transactions corresponding to completed program operations may be rearranged in the order the write requests are issued by using the time stamp information. Accordingly, memory controller 110 may determine an order mapping information regarding write transactions corresponding to completed program operations are to be updated based on the order write requests are issued. Memory controller 110 may determine an order mapping information regarding only pending write transactions with respect to a same LPN corresponding to completed program operations are to be updated based on the order write requests are issued.

Memory controller 110 updates mapping information regarding write transactions corresponding to completed program operations to map table information according to the order determined in operation S130-1A (S130-2A).

FIG. 16 is a flowchart illustrating another example of details of operation for updating mapping information of FIG. 13, according to an embodiment of the inventive concept.

An operation S130B for updating mapping information of FIG. 15 shows an example of updating mapping information in a case where dependency information included in write transaction information is link information indicating the order write requests with respect to a same LPN are issued.

Memory system 100 determines the initial order for updating mapping information regarding write transactions based on the order program operations are completed (S130-1B). In other words, regardless of the order write requests are issued, memory controller 110 determines the order for updating mapping information regarding write transactions based on the order program operations are completed in memory devices.

Next, memory controller 110 modifies the initial order for updating mapping information based on link information included in the write transaction information (S130-2B). For example, the initial order for updating mapping information regarding multiple write transactions with respect to a same LPN is modified based on the order write requests are issued by using the link information include in write transaction information. For example, as of FIGS. 12A and 12B, the order for updating mapping information regarding multiple write transactions with respect to a same LPN may be determined based on the order mapping information are to be updated.

Next, memory controller 110 updates mapping information regarding write transactions corresponding to completed program operations to map table information according to the order modified in operation S130-2B (S130-3B).

FIG. 17 is a block diagram illustrating an electronic device 1000 employing a memory system, according to an embodiment of the inventive concept.

Referring to FIG. 17, electronic device 1000 comprises a CPU 220, a RAM 230, a user interface (UI) 240, an application chipset 250, and memory system 100 that are mutually connected via buses 210. Electronic device 1000 may be, for instance, a computer system, such as a laptop computer and a desktop computer, a personal digital assistant (PDA), a digital camera, or a game device.

FIG. 18 is a block diagram illustrating another electronic device 2000 employing a memory system according to an embodiment of the inventive concept.

Referring to FIG. 18, electronic device 2000 may comprise a mobile device, such as a mobile phone and a smart phone, or a tablet PC.

Electronic device 2000 comprises memory system 100 (e.g., a SSD), a CPU 310, a wireless transceiver 320, an input device 330, a display unit 340, and an antenna 350.

Wireless transceiver 320 transmits/receives wireless signals to/from a station via antenna 350. Wireless transceiver 320 translates received wireless signals to signals that may be processed by CPU 310.

CPU 310 controls the overall operations of electronic device 2000. Furthermore, CPU 310 may process signals output by wireless transceiver 320 and store the processed signals in memory system 100 or display the processed signals via display unit 340.

Input device 330 is a device for inputting control signals for controlling operations of CPU 310 or data to be processed by CPU 310 and may be, for instance, a touch pad, a mouse, a keypad, or a keyboard.

FIG. 19 is a block diagram illustrating a network system 3000 comprising a memory system according to an embodiment of the inventive concept.

Referring to FIG. 19, network system 3000 comprises a server system 400 and multiple terminals 500_1 through 500_{—}n that are connected via a network. Server system 400 comprises a server 410 for processing requests received from terminals 500_1 through 500_{—}n connected via the network and a SSD 100 for storing data corresponding to the requests received from terminals 500_1 through 500_{—}n. Here, SSD 100 may be memory system 100 of FIG. 1.

Various devices and systems described above may be mounted in various types of packages. For example, a memory system according to an embodiment of the inventive concept may be mounted in packages of types such as Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), or Wafer-Level Processed Stack Package (WSP).

The foregoing is illustrative of embodiments and is not to be construed as limiting thereof. Although a few embodiments have been described, those skilled in the art will readily appreciate that many modifications are possible in the embodiments without materially departing from the scope of the inventive concept. Accordingly, all such modifications are intended to be included within the scope of the inventive concept as defined in the claims.

What is claimed is:

1. A method of updating mapping information for a memory system, comprising:
generating write transaction information based on multiple write requests issued by a host;
performing program operations in the memory system based on the write transaction information; and
following completion of the program operations, updating mapping information based on an order in which the write requests were issued by the host.

2. The method of claim 1, wherein the write transaction information comprises a logical page number (LPN), a physical page number (PPN), and dependency information generated based on an order write requests were issued.

3. The method of claim 2, wherein the dependency information comprises time stamp information indicating times at which write requests were issued.

4. The method of claim 2, wherein the dependency information comprises link information indicating the order pending write requests regarding a same LPN are issued

5. The method of claim 1, wherein the generating of the write transaction information comprises:
dividing the write request based on a data processing size of a memory device;
translating addresses with respect to each of the divided write requests; and
generating the write transaction information based on a result of the translating of the addresses.

6. The method of claim 1, wherein, in the generating of the write transaction information, where multiple write requests with respect to same LPN are pending, write transaction information regarding the same LPN is generated, such that a previous write transaction information comprises link information indicating a next write transaction and a new write transaction information comprises link information indicating a previous transaction.

7. The method of claim 1, wherein, in the performing of the program operations, where multiple write requests with respect to same LPN are pending, program operations according to newly issued write requests are performed after program operations according to previously issued write requests are performed, based on dependency information among the write transaction information.

8. The method of claim 1, wherein the updating of the mapping information comprises:
determining an order for updating mapping information based on the order write requests are issued by using time stamp information in the write transaction information; and
updating the mapping information to map table information according to the determined order.

9. The method of claim 1, wherein the updating of the mapping information comprises:
determining the initial order for updating mapping information regarding write transactions based on the order program operations are completed;
modifying the initial order for updating mapping information based on link information included in the write transaction information; and
updating the mapping information to map table information according to the modified order.

10. The method of claim 1, wherein, in the updating of the mapping information, by using link information in the write transaction information, updating operations with respect to mapping information based on previously issued write requests regarding a same LPN are skipped, and mapping information with respect to the latest write requests regarding a same LPN is updated.

11. A memory system comprising:
multiple memory devices each comprising multiple memory banks; and
a memory controller that generates write transaction information based on write requests, controls program operations based on the write transaction information, and, after the program operations are completed, updates mapping information based on an order in which the write requests were issued.

12. The memory system of claim 11, wherein the memory controller comprises:
a random access memory (RAM) for storing map table information; and
a central processing unit (CPU) that generates write transaction information based on write requests, performs program operations by using the write transaction information, and, after the program operations are completed, updates the map table information based on the order the write requests were issued.

13. The memory system of claim 12, wherein the memory controller further comprises a map update queue for storing mapping information regarding write requests corresponding to completed program operations,
wherein the memory controller rearranges mapping information stored in the map update queue based on the order the write requests are issued by using the write transaction information and updates mapping information sequentially read from the rearranged map updated queue to the map table information.

14. The memory system of claim 12, wherein the CPU modifies the order for updating mapping information with respect to a same LPN based on write requests are issued by using link information included in the write transaction information, and updates the mapping information to the map table information according to the modified order.

15. The memory system of claim 12, wherein the memory controller reads map table information from the RAM and writes the map table information to the memory device before the memory system is turned off, and where the memory system is turned on, the memory controller reads the map table information from the memory devices and stores the map table information in the RAM.

16. An apparatus, comprising:
a memory controller configured to generate write transaction information based on multiple write requests received from a host, control program operations performed on a plurality of memory devices based on the write transaction information, and, after the program operations are completed, update mapping information based on an order in which the write requests were issued by the host.

17. The apparatus of claim 16, wherein the memory controller comprises:
a random access memory (RAM) for storing map table information; and
a central processing unit (CPU) that generates write transaction information based on write requests, performs program operations by using the write transaction information, and, after the program operations are completed, updates the map table information based on the order the write requests were issued.

18. The apparatus of claim 17, wherein the memory controller further comprises a map update queue for storing mapping information regarding write requests corresponding to completed program operations,
wherein the memory controller rearranges mapping information stored in the map update queue based on the order the write requests are issued by using the write transaction information and updates mapping information sequentially read from the rearranged map updated queue to the map table information.

19. The apparatus of claim 17, wherein the CPU modifies the order for updating mapping information with respect to a same LPN based on write requests are issued by using link information included in the write transaction information, and updates the mapping information to the map table information according to the modified order.

20. The apparatus of claim 17, wherein the memory controller reads map table information from the RAM and writes the map table information to the memory device before the memory system is turned off, and where the memory system is turned on, the memory controller reads the map table information from the memory devices and stores the map table information in the RAM.
